(19) United States
(12) Patent Application Publication
(10) Pub. No.: US 2025/0182241 A1
(43) Pub. Date: Jun. 5, 2025

(54) Deep Learning-Based Fusion Techniques for High Resolution Images

(71) Applicant: Apple Inc., Cupertino, CA (US)

(72) Inventors: Jianping Zhou, Fremont, CA (US); Feng Li, Fremont, CA (US); Jia Xue, Fremont, CA (US); Jianrui Cai, San Jose, CA (US)

(21) Appl. No.: 18/957,535

(22) Filed: Nov. 22, 2024

Related U.S. Application Data
(60) Provisional application No. 63/604,269, filed on Nov. 30, 2023.

(51) Int. Cl. G06T 3/4046; G06T 5/50; G06T 5/60

(52) U.S. Cl. CPC G06T 3/4046; G06T 5/50; G06T 5/60; G06T 2207/20084; G06T 2207/20221

(57) ABSTRACT

Electronic devices, methods, and program storage devices for leveraging machine learning to perform high-resolution and low latency image fusion and/or noise reduction are disclosed. An incoming image stream may be obtained from an image capture device, wherein the incoming image stream comprises a variety of different resolutions and/or differently-exposed captures, e.g., EV0 images, EV− images, EV+ images, long exposure images, etc., which are received according to a particular pattern. When a capture request is received, two or more intermediate assets may be generated from images from the incoming image stream using deep neural networks, and then the intermediate assets may be fed into a neural network that has been trained to transfer additional image detail from one intermediate asset to the other. In some embodiments, a resultant output image generated from the two or more intermediate assets may have a higher resolution than at least one of the intermediate assets.

### TECHNICAL FIELD

This disclosure relates generally to the field of digital image processing. More particularly, but not by way of limitation, it relates to techniques for leveraging machine learning to perform high-resolution and low latency image fusion and noise reduction for captured images having a variety of resolutions and/or exposure times.

### BACKGROUND

Fusing multiple images of the same captured scene is an effective way of increasing signal-to-noise ratio (SNR) in the resulting fused image. This is particularly important for small and/or thin form factor devices-such as mobile phones, tablets, laptops, wearables, etc.—for which the pixel size of the device's image sensor(s) is often quite small. The smaller pixel size means that there is comparatively less light captured per pixel (i.e., as compared to a full-sized, standalone camera having larger pixel sizes), resulting in more visible noise in captured images—especially in low-light situations.

The multiple image captures used in a given fusion operation may comprise: multiple images captured with the same exposure (e.g., for the purposes of freezing motion), which may be referred to as Still Image Stabilization (SIS); multiple images captured with different exposures (e.g., for the purposes of highlight recovery, as in the case of High Dynamic Range (HDR) imaging); or a combination of multiple images captured with shorter and longer exposures, as may be captured when an image capture device's Optical Image Stabilization (OIS) system is engaged, e.g., for the purposes of estimating the moving pixels from the shorter exposures and estimating the static pixels from the long exposure(s). Moreover, the captured images that are to be fused can come from, e.g., the same camera, multiple cameras with different image sensor characteristics (e.g., cameras with different lenses and/or native sensor resolutions, such as a relatively higher-resolution image sensor and a relatively lower-resolution image sensor), or different image processing workflows from the same image sensor (e.g., a full or “high resolution” output image from a given image sensor and a binned or “low resolution” output image from the same image sensor).

In some prior art image fusion schemes, multiple image heuristics may need to be calculated, tuned, and/or optimized by design engineers (e.g., on a relatively small number of test images), in order to attempt to achieve a satisfactory fusion result across a wide variety of image capture situations. However, such calculations and optimizations are inherently limited by the small size of the test image sets from which they were derived. Further, the more complicated that such calculations and optimizations become, the more computationally-expensive such fusion techniques are to perform on a real-world image capture device.

Thus, what is needed is an approach to leverage machine learning-based techniques to improve the fusion and noise reduction of bracketed captures of arbitrary exposure levels and varying resolutions, wherein the improved fusion and noise reduction techniques are optimized over much larger training sets of images and may be performed in a memory-efficient and low-latency manner. However, as higher and higher resolution image sensors become available for inclusion in consumer-grade electronic devices, new technical challenges are introduced, e.g., in terms of power, memory, and system performance constraints. Moreover, the additional latency involved in capturing such high-resolution photographs may prevent a user from capturing an image of the scene that represents the exact intended moment in time of an image capture request. This may be particularly noticeable when photographing highly dynamic scenes (e.g., sporting events, moving children, pets, etc.).

In such instances, the ability of the camera to capture the exact intended moment in time in such scenes may be equally (or even more) important to the user than the final image's noise level, color reproduction quality, or resolution level. Ideally, a user would like to have a high-resolution photograph that also captures the exact intended moment in time from the captured scene. Thus, presented herein are techniques for performing image capturing and neural network-based image fusion that avoid (or reduce) the effects of system latencies and provide the user with a high resolution (and high quality) output image that accurately represents the scene at the intended moment in time, i.e., that does not exhibit undesirable shutter lag.

### SUMMARY

Devices, methods, and non-transitory program storage devices are disclosed herein that leverage machine learning (ML) and other artificial intelligence (AI)-based techniques (e.g., deep neural networks (DNNs)) to perform high-resolution and low latency image fusion and/or noise reduction, in order to generate low-noise and high dynamic range (HDR) images from images captured by a variety of lenses and/or having a variety of resolutions and exposure times.

More particularly, an incoming image stream may be obtained from one or more image capture devices, wherein the incoming image stream comprises a variety of different resolutions and/or differently-bracketed image captures, which are, e.g., received in a particular sequence and/or according to a particular pattern. When an image capture request is received, the method may then generate, in response to the capture request, two or more intermediate assets, wherein at least two of the intermediate assets comprise “image-based” intermediate assets, e.g., images generated (e.g., by one or more trained deep neural networks) using a determined one or more images form the incoming image stream.

According to some embodiments, one or more high-resolution image assets (e.g., images having a higher resolution than the constituent images from the incoming image stream) may also be captured in response to receiving an image capture request. As will be described herein, a deep neural network may also be used to transfer additional detail from such high-resolution image assets to the other lower-resolution image assets used in the neural image fusion process in an intelligent and memory-efficient way.

In some cases, the final generated output image may have the same resolution as the one or more high-resolution image assets. In other cases, the one or more high-resolution image assets may be downscaled before the final neural image fusion process with the other lower-resolution image assets, resulting in a final generated output image having a resolution that is still higher than the other lower-resolution image assets, though not as great as the native resolution of the originally-captured high-resolution image assets. According to still other embodiments, one or more long exposure image assets may also be captured in response to receiving the image capture request and then used in an intelligent fashion in the neural image fusion process.

As mentioned above, various electronic device embodiments are disclosed herein. Such electronic devices may include one or more image capture devices, such as optical image sensors/camera units; a display; a user interface; one or more processors; and a memory coupled to the one or more processors. Instructions may be stored in the memory, the instructions causing the one or more processors to execute instructions to: obtain an incoming image stream from the one or more image capture devices (e.g., an incoming image stream comprising images with two or more different resolutions and/or exposure values); receive an image capture request via the user interface; generate, in response to the image capture request, two or more intermediate assets, wherein: a first intermediate asset of the generated two or more intermediate assets comprises an image generated by a first neural network configured to perform a fusion operation on a determined first one or more images from the incoming image stream, and wherein the first intermediate asset has a first resolution; and a second intermediate asset of the generated two or more intermediate assets comprises an image generated by a second neural network configured to perform an image enhancement operation (e.g., a denoising operation and/or demosaicing operation) operation on at least a second image from the incoming image stream, wherein the second image has a second resolution, and wherein the second resolution is greater than the first resolution.

Next, the instructions may cause the one or more processors to execute instructions to: feed the first and second intermediate assets into a third neural network, wherein the third neural network is configured to combine the first and second intermediate assets to generate an output image having a resolution greater than the first resolution; and, finally, generate the output image using the third neural network.

In some embodiments, one or more of the first one or more images are captured before the image capture request is received, while, in other embodiments, one or more of the first one or more images (and/or the second image) may also be captured after the image capture request is received.

In some embodiments, the second neural network is further configured to perform a demosaicing operation on the second image from the incoming image stream.

In some embodiments, the second neural network is further configured to perform the image enhancement operation on a cropped region (e.g., a central cropped region) from the second image from the incoming image stream.

In some embodiments, the second resolution is greater than the first resolution by a factor of n, wherein n is greater than or equal to 2 (e.g., 2× greater, 4× greater, 8× greater, 9× greater, 16× greater, etc.).

In some embodiments, the output image has an improved detail level and/or lower noise levels compared to the first intermediate asset.

In some embodiments, the third neural network is further configured to operate on tiles of the first intermediate asset and tiles of the second intermediate asset (wherein each tile comprises a sub-portion of pixels in the image, e.g., a rectangular sub-portion).

In some such embodiments, the one or more processors are further configured to execute instructions causing the one or more processors to perform a per-tile homography estimation between tiles of the second intermediate asset and tiles of the first intermediate asset.

In other such embodiments, the one or more processors are further configured to execute instructions causing the one or more processors to identify a guidance tile in the second intermediate asset for each tile in the first intermediate asset (e.g., a guidance tile may comprise a tile from one image that is closest matching to a tile from another image in feature space).

In still other such embodiments, the third neural network is further configured to transfer details to each tile in the first intermediate asset from its corresponding guidance tile in the second intermediate asset.

In some embodiments, the third neural network is further configured to generate the output image having a resolution configured to simulate a particular prime lens (e.g., to simulate a field of view (FOV) of a 24 mm equivalent fixed focal length camera, a 28 mm equivalent fixed focal length camera, a 35 mm equivalent fixed focal length camera, a 48 mm equivalent fixed focal length camera, etc.), subject to any further desired post-processing, such as hardware scaling, rotation, or the like.

In some embodiments, the output image has the second resolution.

Various methods of performing high-resolution and low latency machine learning-enhanced image fusion and/or noise reduction are also disclosed herein, in accordance with the various electronic device embodiments enumerated above. Non-transitory program storage devices are also disclosed herein, which non-transitory program storage devices may store instructions for causing one or more processors to perform operations in accordance with the various electronic device embodiments enumerated above.

### BRIEF DESCRIPTION OF THE DRAWINGS

FIG. 1 illustrates an exemplary incoming image stream that may be used to generate a one or more intermediate assets to be used in a machine learning-enhanced image fusion and/or noise reduction method, according to one or more embodiments.

FIG. 2 illustrates an overview of a process for performing high-resolution and low latency machine learning-enhanced image fusion and/or noise reduction, according to one or more embodiments.

FIG. 3 is an example of a neural network architecture that may be used for performing high-resolution and low latency machine learning-enhanced image fusion and/or noise reduction, according to one or more embodiments.

FIG. 4 is a flow chart illustrating a method of performing high-resolution and low latency machine learning-enhanced image fusion and/or noise reduction using one or more intermediate assets, according to one or more embodiments.

FIG. 5 is a block diagram illustrating a programmable electronic computing device, in which one or more of the techniques disclosed herein may be implemented.

### DETAILED DESCRIPTION

In the following description, for purposes of explanation, numerous specific details are set forth, in order to provide a thorough understanding of the inventions disclosed herein. It will be apparent, however, to one skilled in the art that the inventions may be practiced without these specific details. In other instances, structure and devices are shown in block diagram form to avoid obscuring the inventions. References to numbers without subscripts or suffixes are understood to reference all instance of subscripts and suffixes corresponding to the referenced number. Moreover, the language used in this disclosure has been principally selected for readability and instructional purposes, and it may not have been selected to delineate or circumscribe the inventive subject matter, and, thus, resort to the claims may be necessary to determine such inventive subject matter. Reference in the specification to “one embodiment” or to “an embodiment” means that a particular feature, structure, or characteristic described in connection with the embodiments is included in at least one embodiment of one of the inventions, and multiple references to “one embodiment” or “an embodiment” should not be understood as necessarily all referring to the same embodiment.

Discussion will now turn to the nomenclature that will be used herein to refer to the various differently-exposed images from an incoming image stream. As in conventional bracket notation, “EV” stands for exposure value and refers to a given exposure level for an image (which may be controlled by one or more settings of a device, such as an image capture device's shutter speed and/or aperture setting). Different images may be captured at different EVs, with a one EV difference (also known as a “stop”) between images equating to a predefined power difference in exposure. Typically, a stop is used to denote a power of two difference between exposures. Thus, changing the exposure value can change an amount of light received for a given image, depending on whether the EV is increased or decreased. For example, one stop doubles (or halves) the amount of light received for a given image, depending on whether the EV is increased (or decreased), respectively.

The “EV0” image in a conventional bracket refers to an image that is captured using an exposure value as determined by an image capture device's exposure algorithm, e.g., as specified by an Auto Exposure (AE) mechanism. Generally, the EV0 image is assumed to have the ideal exposure value (EV) given the lighting conditions at hand. It is to be understood that the use of the term “ideal” in the context of the EV0 image herein refers to an ideal exposure value, as calculated for a given image capture system. In other words, it is a system-relevant version of ideal exposure. Different image capture systems may have different versions of ideal exposure values for given lighting conditions and/or may utilize different constraints and analyses to determine exposure settings for the capture of an EV0 image.

The term “EV−” image refers to an underexposed image that is captured at a lower stop (e.g., 0.5, 1, 2, or 3 stops) than would be used to capture an EV0 image. For example, an “EV− 1” image refers to an underexposed image that is captured at one stop below the exposure of the EV0 image, and “EV− 2” image refers to an underexposed image that is captured at two stops below the exposure value of the EV0 image. The term “EV+” image refers to an overexposed image that is captured at a higher stop (e.g., 0.5, 1, 2, or 3) than the EV0 image. For example, an “EV+1” image refers to an overexposed image that is captured at one stop above the exposure of the EV0 image, and an “EV+2” image refers to an overexposed image that is captured at two stops above the exposure value of the EV0 image.

For example, according to some embodiments, the incoming image stream may comprise a combination of: EV−, EV0, EV+, and/or other longer exposure images. It is further noted that the image stream may also comprise a combination of arbitrary exposures, as desired by a given implementation or operating condition, e.g., EV+2, EV+4, EV−3 images, etc.

As mentioned above, in image fusion, one of the images to be fused is typically designated as the reference image for the fusion operation, to which the other candidate images involved in the fusion operation are registered. Reference images are often selected based on being temporally close in capture time to the moment that the user intends to “freeze” in the captured image. In order to more effectively freeze the motion in the captured scene, reference images may have a relatively shorter exposure time (e.g., shorter than a long exposure image) and thus have undesirable amounts of noise. As such, reference images may benefit from being fused with one or more additional images, in order to improve the reference image's original noise characteristics, while still sufficiently freezing the desired moment in the scene.

Thus, according to some embodiments, enhanced images (also referred to herein as “intermediate assets”) may be synthesized, e.g., by one or more deep neural networks, from multiple captured images that are fused together in feature space by such deep neural networks. According to other embodiments, a high resolution captured image may also be enhanced, e.g., denoised, demosaiced, and/or further upscaled and/or downscaled, as desired, e.g., by one or more deep neural networks, the resulting enhanced image of which may also be referred to herein as an “intermediate asset.” Two or more of such intermediate assets (e.g., produced by deep neural networks) may themselves be used as inputs to in a neural image fusion process, which is ultimately designed to transfer details from a higher-resolution intermediate asset to corresponding portions of a lower-resolution intermediate asset in an intelligent and multi-scale fashion, thereby generating an output fused image having a resolution and detail level that is greater than at least one of the initially-generated intermediate assets.

According to some embodiments, long exposure images may comprise an image frame captured to be over-exposed relative to an EV0 exposure setting. In some instances, it may be a predetermined EV+ value (e.g., EV+1, EV+2, etc.). In other instances, the exposure settings for a given long exposure image may be calculated on-the-fly at capture time (e.g., within a predetermine range). A long exposure image may come from a single image captured from a single camera, or, in other instances, a long exposure image may be synthesized from multiple captured images that are fused together (the result of which may be referred to as a “synthetic long image,” “synthetic long exposure image” or “SL” image). According to other embodiments, the synthetic long image may also simply be the result of selecting a single bracketed capture (i.e., without fusion with one or more other bracketed captures). For example, a single EV+2 long exposure image may serve as the synthetic long image in a given embodiment.

Use of the term “intermediate assets” herein refers to the fact that a particular asset is not typically an image that is captured directly by an image senor (e.g., other than the scenarios wherein a particular single bracketed image capture may be selected to serve as an intermediate asset). Instead, intermediate assets are typically synthesized by a deep neural network and/or fused from two or more images that were directly captured by the image sensor. Intermediate assets are referred to as “intermediate,” e.g., due to the fact that they may be generated and used during an intermediate time period between the real-time capture of the images by the image sensors of the device and the generation of a final, fused output image. The intelligent use of intermediate assets may allow for fusion operations to benefit (to at least some extent) from both the additional light information captured by a larger number of bracketed exposure captures, as well as the additional detail that is recoverable from higher-resolution image captures, while still maintaining the processing and memory efficiency benefits of performing the actual fusion operation (e.g., leveraging potentially processing-intensive deep learning techniques) using only the smaller number of intermediate assets.

In instances where the image capture device is capable of performing OIS, the OIS may be actively stabilizing the camera and/or image sensor during capture of the long exposure image and/or one or more of the other captured images. (In other embodiments, there may be no OIS stabilization employed during the capture of the other, i.e., non-long exposure images, or a different stabilization control technique may be employed for such non-long exposure images). In some instances, an image capture device may only use one type of long exposure image. In other instances, the image capture device may capture different types of long exposure images, e.g., depending on capture conditions. For example, in some embodiments, a synthetic long exposure image may be created when the image capture device does not or cannot perform OIS, while a single long exposure image may be captured when an OIS system is available and engaged at the image capture device.

According to some embodiments, in order to recover a desired amount of shadow detail in the captured image, some degree of overexposure (e.g., EV+2) may intentionally be employed in bright scenes and scenes with medium brightness. Thus, in certain brighter ambient light level conditions, the long exposure image itself may also comprise an image that is overexposed one or more stops with respect to EV0 (e.g., EV+3, EV+2, EV+1, etc.). To keep brightness levels consistent across long exposure images, the gain may be decreased proportionally as the exposure time of the capture is increased, as, according to some embodiments, brightness may be defined as the product of gain and exposure time.

In some embodiments, long exposure images may comprise images captured with greater than a minimum threshold exposure time, e.g., 50 milliseconds (ms) and less than a maximum threshold exposure time, e.g., 250 ms, 500 ms, or even 1 second. In other embodiments, long exposure images may comprise images captured with a comparatively longer exposure time than a corresponding normal or “short” exposure image for the image capture device, e.g., an exposure time that is 4 to 30 times longer than a short exposure image's exposure time. In still other embodiments, the particular exposure time (and/or system gain) of a long exposure image may be further based, at least in part, on ambient light levels around the image capture device(s), with brighter ambient conditions allowing for comparatively shorter long exposure image exposure times, and with darker ambient conditions allowing the use of comparatively longer long exposure image exposure times. In still other embodiments, the particular exposure time (and/or system gain) of a long exposure image may be further based, at least in part, on whether the image capture device is using an OIS system during the capture operation.

It is to be noted that the noise level in a given image may be estimated based, at least in part, on the system's gain level (with larger gains leading to larger noise levels). Therefore, in order to have low noise, an image capture system may desire to use small gains. However, as discussed above, the brightness of an image may be determined by the product of exposure time and gain. So, in order to maintain the image brightness, low gains are often compensated for with large exposure times. However, longer exposure times may result in motion blur, e.g., if the camera doesn't have an OIS system and/or if there is significant camera shake during the long exposure image capture. Thus, for cameras that have an OIS system, exposure times could range up to the maximum threshold exposure time in low light environments, which would allow for the use of a small gain- and hence less noise. However, for cameras that do not have OIS systems, the use of very long exposure times will likely result in motion blurred images, which is often undesirable. Thus, as may now be understood, the long exposure image's exposure time may not always be the maximum threshold exposure time allowed by the image capture device.

According to some embodiments, the incoming image stream may comprise a particular sequence and/or a particular pattern of exposures. For example, according to some embodiments, the sequence of incoming images may comprise: EV0, EV−, EV0, EV−, and so forth. In other embodiments, the sequence of incoming images may comprise only EV0 images. In response to a received capture request, according to some embodiments, the image capture device may take one (or more) “high resolution” images and one (or more) long exposure images. After the long exposure capture, the image capture device may return to a particular sequence of incoming image exposures, e.g., the aforementioned: EV0, EV−, EV0, EV− sequence. The sequence of exposures may, e.g., continue in this fashion until a subsequent capture request is received, the camera(s) stop capturing images (e.g., when the user powers down the device or disables a camera application), and/or one when or more operating conditions may change. In still other embodiments, the image capture device may capture one or more additional EV0 images (referred to herein as “pre-bracket” or PB captures) in response to an image capture request that is received during an image streaming mode but before the appropriate bracketed captures are obtained in response to said image capture request. The device may then fuse the additional EV0 exposure images (along with, optionally, one or more additional EV0 images captured prior to the received capture request and long exposure images, if so desired) into an intermediate asset using a deep neural network, as discussed above, which intermediate asset may be used in additional downstream machine learning-enhanced image fusion and/or noise reduction processes, such as those described herein. According to some embodiments, the images in the incoming image stream may be captured as part of a preview operation of a device, or otherwise be captured while the device's camera(s) are active, so that the camera may more quickly react to a user's image capture request. Returning to the sequence of incoming images may ensure that the device's camera(s) are ready for the next image capture request.

According to some embodiments, the terms “high-resolution” (or “higher-resolution”) and “low-resolution” (or “lower-resolution”) may be used herein to refer to relative differences in the number of pixel values produced by an image sensor for a particular captured image. For example, a “high-resolution” image may refer to an image that is captured with a greater number of pixels than a “low-resolution” image in the same incoming image stream. In some embodiments, high-resolution images may comprise images captured with greater than a minimum threshold resolution, e.g., greater than 12 megapixels (MP), greater than 24 MP, etc.

In other embodiments, as mentioned above, high-resolution image may comprise images captured natively with a comparatively greater resolution level than a corresponding normal or “low” resolution image for the image capture device, e.g., a resolution level that is 2×, 4×, 8×, or 9× etc., larger than a so-called low-resolution image's resolution. In some cases, a higher-resolution image sensor may have a pixel color pattern that mirrors an existing color filter array (CFA) pattern, e.g., a Bayer color filter array pattern used by a “low resolution” image sensor, but with more granular detail. For example, if a typical Bayer pattern followed a pixel pattern of:
BGBG . . .
GRGR . . .
then a 4× higher-resolution image sensor may follow the same Bayer color filter pattern, but, instead, further subdivide each pixel location from the “low resolution” Bayer CFA image sensor pattern into a 2×2 grid of pixels of the same color, thereby causing the 8 pixels in the example pattern produced above to instead be represented on the sensor as 8×4 or 32 pixels on the higher-resolution image sensor, in a pattern such as:
BBGGBBGG. . . .
BBGGBBGG. . . .
GGRRGGRR. . . .
GGRRGGRR . . .

Other color filter array patterns and ways of achieving higher-resolution images are also possible, with the above example being but one such option. In still other embodiments, as will be explained in greater detail below, the particular resolution of a high-resolution image as used in a neural image fusion process may be further based, at least in part, on an amount of binning applied the image capture device(s), with higher levels of binning resulting in smaller and smaller sized high-resolution image representations. In some cases, determining an amount of binning may be a tradeoff between a loss in image detail level and a gain in overall processing/memory/power efficiency by being able to operate on images having smaller overall memory footprints.

### Exemplary Incoming Image Stream

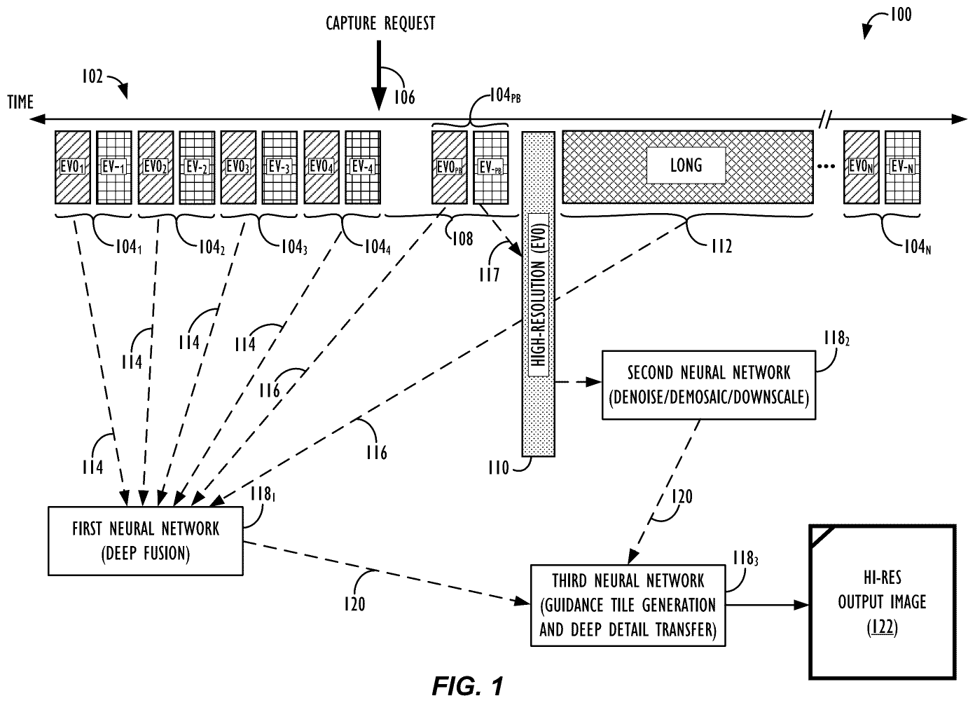

Referring now to FIG. 1, an exemplary incoming image stream 100 that may be used to generate one or more intermediate assets to be used in a machine learning-enhanced image fusion and/or noise reduction method is illustrated, according to one or more embodiments. Images from incoming image stream 100 may be captured along a timeline, e.g., exemplary image capture timeline 102, which runs from left to right across FIG. 1. It is to be understood that this timeline is presented merely for illustrative purposes, and that a given incoming image stream could be captured for seconds, minutes, hours, days, etc., based on the capabilities and/or needs of a given implementation.

According to some embodiments, EV0 image frames in the incoming image stream may, by default, be captured according to a first frame rate, e.g., 15 frames per second (fps), 30 fps, 60 fps, etc. In some embodiments, this frame rate may remain constant and uninterrupted, unless (or until) an image capture request 106 is received at the image capture device. In other embodiments, the frame rate of capture of EV0 image frames may vary over time, based on, e.g., one or more device conditions, such as device operational mode, available processing resources, ambient lighting conditions, thermal conditions of the device, etc.

In other embodiments, one or more captured EV0 images may be paired with another image as part of a so-called “secondary frame pair” (SFP). The SFP, according to some embodiments, may comprise an image that is captured and read out from the image sensor consecutively, e.g., immediately following, the capture of the corresponding EV0 image. In some embodiments, the SFP may comprise an EV0 image and: an EV−1 image frame, an EV−2 image frame, or an EV−3 image frame, etc. EV− images will have a lower exposure time and thus be somewhat darker and have more noise than their EV0 counterpart images, but they may do a better job of freezing motion and/or representing detail in the darker regions of images.

In the example shown in FIG. 1, SFPs 104 are captured sequentially by the image capture device (e.g., 104₁, 104₂, 104₃, 104₄, and so forth), with each SFP including two images with differing exposure values, e.g., an EV0 image and a corresponding EV− image. Note that the EV0 and EV− images illustrated in FIG. 1 use a subscript notation (e.g., EV−1, EV−2, EV−3, EV−4, and so forth). This subscript is simply meant to denote different instances of images being captured (and not different numbers of exposure stops). It is to be understood that, although illustrated as pairs of EV0 and EV− images in the example of FIG. 1, any desired pair of exposure levels could be utilized for the images in an SFP, e.g., an EV0 image and an EV−2 image, or an EV0 image and in EV−3 image, etc. In other embodiments, the SFP may even comprise more than two images (e.g., three or four images), based on the capabilities of the image capture device.

In some embodiments, the relative exposure settings of the image capture device during the capture of the images comprising each SFP may be driven by the image capture device's AE mechanism. Thus, in some instances, the exposure settings used for each SFP may be determined independently of the other captured SFPs. In some instances, the AE mechanism may have a built-in delay or lag in its reaction to changes in ambient lighting conditions, such that the AE settings of the camera do not change too rapidly, thereby causing undesirable flickering or brightness changes. Thus, the exposure settings for a given captured image (e.g., EV0 image, EV− image, and/or EV+ image) may be based on the camera's current AE settings. Due to the consecutive nature of the readouts of the images in an SFP, it is likely that each image in the SFP will be driven by the same AE settings (i.e., will be captured relative to the same calculated EV0 settings for the current lighting conditions). However, if the delay between captured images in an SFP is long enough and/or if the camera's AE mechanism reacts to ambient lighting changes quickly enough, in some instances, it may be possible for the images in a given SFP to be driven by different AE settings (i.e., the first image in the SFP may be captured relative to a first calculated EV0 setting, and the second image in the SFP may be captured relative to a second calculated EV0 setting). Of course, outside of the context of SFPs, it may also be possible for consecutive captured images, e.g., from an incoming image stream, to be captured relative to different calculated EV0 settings, again based, e.g., on changing ambient lighting conditions and the rate at which the camera's AE mechanism updates its calculated EV0 settings.

According to some embodiments, the capture frame rate of the incoming image stream may change based on the ambient light levels (e.g., capturing at 30 frames-per-second, or fps, in bright light conditions and at 15 fps in low light conditions). In one example, assuming that the image sensor is streaming captured images at a rate of 30 fps, the consecutive SFP image pairs (e.g., EV0, EV−) are also captured at 30 fps. The time interval between any two such SFP captures would be 1/30^{th} of a second, and such interval may be split between the capturing of the two images in the SFP, e.g., the EV0 and EV− images. According to some embodiments, the first part of the interval may be used to capture the EV0 image of the pair, and last part of the interval may be used to capture the EV− image of the pair. Of course, in this 30 fps example, the sum of the exposure times of the EV0 and EV− images in a given pair cannot exceed 1/30^{th} of a second. In still other embodiments, the capture of the EV− image from each SFP may be disabled based on ambient light level. For example, below a threshold scene lux level, the capture of the EV− image from each SFP may simply be disabled, since any information captured from such an exposure may be too noisy to be useful in a subsequent fusion operation.

Moving forward along timeline 102 to the capture request 106, according to some embodiments, one or more additional EV0 and EV− image pairs (e.g., pre-bracket or “PB” image pair 104_{PB}) may be taken during a system latency delay interval 108, before the image sensor switches modes to capture one (or more) high-resolution images 110 (e.g., an EV0 high-resolution image having 2×, 4×, etc., as many pixels in resolution as the SFPs 104, which may have been produced, as described above, as a result of image sensor binning, thereby resulting in their relatively lower resolution).

In some embodiments, one or more additional long exposure images, e.g., long exposure image 112, may also be captured by the image capture device in response to the receipt of the capture request 106 (e.g., after the capture of any desired high-resolution image assets, such as 110). As mentioned above, according to some embodiments, a system latency delay 108 may exist in the image capture stream following the receipt of an image capture request 106. In some cases, an additional intentional delay may also be built in to the image capture process following the receipt of an image capture request, e.g., so that any shaking or vibrations caused by a user's touching or selection of a capture button on the image capture device (e.g., either a physical button or software-based user interface button or other graphical element) may be diminished before the initiation of any high resolution and/or long exposure image captures. For example, long exposure images, although more likely to produce a low-noise image, are also more prone to blurring, and thus lack of sharpness, due to the amount of time the shutter stays open during the capture of the long exposure image. As may now be understood, due to various system latencies (as well as the reaction time of the photographer), the image bracket that best represents the captured scene at the instant the user presses the shutter to indicate a desire to capture an image may actually be an image bracket that was captured prior to the shutter press. In other words, in the example of FIG. 1, it may actually be an image from one of the SFPs 104 (e.g., 104₁, 104₂, 104₃, 104₄,) that best captures or “freezes” the moment in time that the photographer intended to capture (and/or has the best sharpness score), and thus may serve as the best “reference” image, against which the other image assets used in the fusion process should be aligned.

Based on the evaluation of one or more capture conditions, the image capture device may then select two or more images captured prior to image capture request 106 (e.g., represented by optional dashed lines 114), as well as one or more images captured subsequently to image capture request 106 (e.g., represented by optional dashed lines 116), for inclusion in an image fusion operation performed by a first neural network 118₁ to generate a first intermediate asset, e.g., a relatively lower resolution intermediate asset that successfully “freezes” the motion of the scene close to the time of the image capture request 106 and is able to reduce noise/increase detail as compared to any single image that is included in the fusion operation performed by first neural network 118₁.

The image capture device may also select one or more additional relatively higher resolution images (e.g., such as high-resolution EV0 image 110 in FIG. 1) for processing by a second neural network 118₂ to generate a second intermediate asset, e.g., a high-resolution image that has been enhanced, i.e., denoised, demosaiced (i.e., if a RAW image asset is input to the network 118₂), and/or downscaled (e.g., if the native or high-resolution size of images captured by the image sensor needs to be downscaled before processing by the third neural network 118₃), as will be described in greater detail below. In some embodiments, the EV− image from the pre-bracket image pair 104_{PB} may be included in an HDR fusion process with the high-resolution EV0 image 110 bracket prior to processing by second neural network 118₂ (e.g., represented by optional dashed line 117). In still other embodiments, if there are enough time/processing resources, a high-resolution EV− image (not illustrated) may also be captured and used in order to perform highlight recovery high-resolution EV0 image 110. Finally, it is to be understood that one or more of the images captured as part of the incoming image stream (or in response to the image capture request 106) may be processed as needed, e.g., by a hardware image signal processor, for highlight recovery/shadow recovery before further processing by any of the neural networks 118.

Once the outputs (i.e., intermediate assets) of first neural network 118₁ and second neural network 118₂ have been created, they may be further fused, e.g., to intelligently transfer additional detail from the higher resolution second intermediate asset from 118₂ to the appropriate and corresponding portions of the lower resolution intermediate asset from 118₁, by a third neural network 118₃ (e.g., represented by dashed lines 120) in order to form the final neural fused image 122. In some embodiments, both first neural network 118₁ and second neural network 118₂ may generate linear RGB output image data, each of which outputs may individually be subject to local tone-mapping, sharpening, subject-relighting, and/or other post-processing operations, as desired, before being fed into third neural network 118₃.

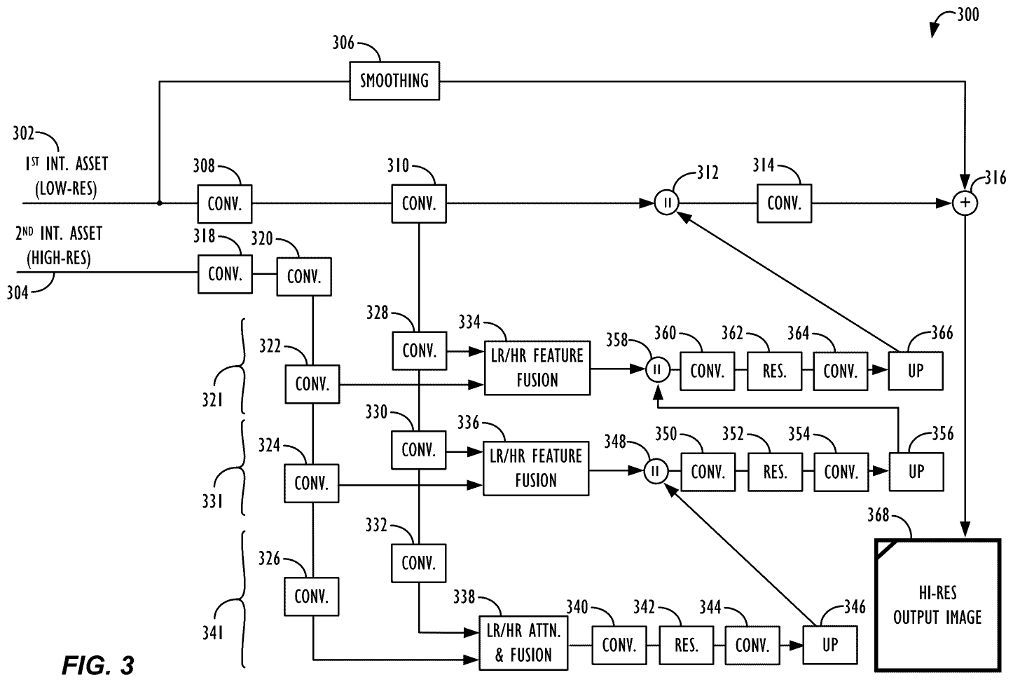

As will be explained in further detail below with reference to FIG. 3, machine learning techniques, e.g., deep neural networks, may be leveraged to determine a preferred or optimal way to fuse and/or transfer relevant details between corresponding sub-portions of the images (e.g., intermediate assets) that are used to generate the final fused image 122.

The final fusion operation by third neural network 118₃ of the selected images and/or intermediate assets from the incoming image stream 100 (e.g., the output of first neural network 118₁ and second neural network 118₂, as illustrated in FIG. 1) will result in the final neural fused output image 122 (wherein the modifier “neural” in this context refers to the fact that the output image 122 is generated via the usage of one or more deep neural networks (DNNs)). The decision of how to ultimately fuse the various images and/or image-based intermediate assets included in the final network fusion operation may be made by one or more trained deep neural networks, e.g., 118₃. As also illustrated in the example of FIG. 1, in some embodiments, after the capture of the long exposure image(s) 112 following the capture request 106, the image capture stream may go back to capturing SFPs 104N, EV0 images, or whatever other pattern of images is desired by a given implementation, e.g., until the next capture request is received, thereby triggering the capture of another high-resolution image(s), and/or long exposure image(s) (and/or the generation of one or more synthetic intermediate assets to be used in the final neural image fusion operation), or until the device's camera functionality is deactivated.

### Deep Neural Network Detail Transfer Process Overview

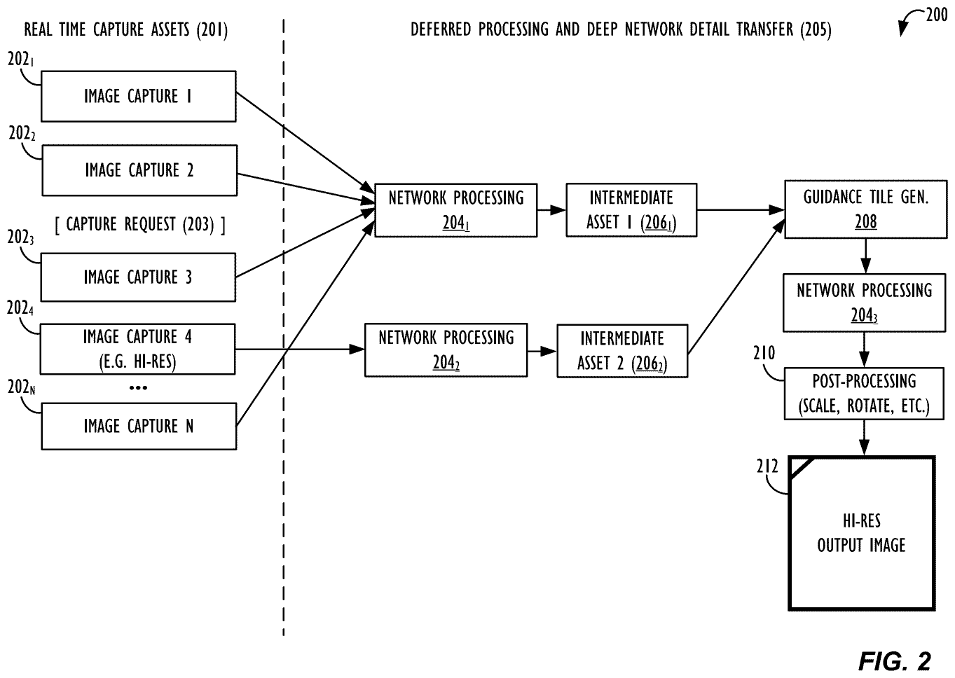

Turning now to FIG. 2, an overview of a process 200 for performing high-resolution and low latency machine learning-enhanced image fusion and/or noise reduction is illustrated, according to one or more embodiments. As described above with reference to FIG. 1, an image capture device may be placed into an image capture mode for capturing one or more “real time” capture assets 201 (e.g., image captures 202₁-202_{N} in FIG. 2, from an incoming image stream). At a given time, a user of the image capture device may issue an image capture request 203, e.g., by the user pressing a physical or virtual shutter button, indicating a desire for one or more images sensors of the image capture device to capture and generate an image of the scene, i.e., as it existed at the moment of the image capture request (or as close as possible to such moment).

Note that, in some implementations, one or more of the image captures 202 may have actually been captured prior to the image capture request 203 (e.g., image captures 202₁ and 202₂), and one or more of the image captures 202 may be captured after the image capture request 203 (e.g., image captures 202₃ and 202₄). In some embodiments, at least one of the images captured after the image capture request 203 (e.g., 202₄, in the example of FIG. 2), may comprise one of the aforementioned high resolution image assets captured by an image sensor of the image capture device. These image captures 202₁ and 202₂ are referred to herein as “real time” or “streaming” capture assets 201, indicating that they are obtained at a rate that is set by the frame rate of the video images captured by the image sensor, e.g., 30 fps. The image captures after the capture request 203 (e.g., image captures 202₃ and 202₄) are referred to herein as “bracketed” captures, indicating that they are obtained in immediate succession in response to the capture request 203, until the image capture device may return to capturing “real time” or “streaming” capture assets, e.g., 202_{N}. The bracketed image captures 202 may comprise, e.g., one or more of the SFPs 104, high-resolution image(s) 110, and/or long exposure image(s) 112, discussed above with reference to FIG. 1.

Turning now to the deferred processing and deep network detail transfer portion (205) of process 200, according to the embodiments described herein, one or more intermediate assets (e.g., intermediate assets 206₁-206₂ in FIG. 2) may be generated, e.g., based on network processing 204 of a combination of two or more of the image captures 202. As described above with reference to FIG. 1, according to some embodiments, one intermediate asset, e.g., Intermediate Asset 1 206₁ in FIG. 2, may comprise a result of a neural fusion operation at network processing block 2041 of two or more lower-resolution real time capture assets (201), and another intermediate asset, e.g., Intermediate Asset 2 206₂ in FIG. 2, may comprise result of a neural processing operation at network processing block 2042 of one or more higher-resolution real time capture assets (201), e.g., image capture 202₄.

One or both of the intermediate assets 206 may be processed and/or scaled (if necessary) and divided into tiles (i.e., sub-portions) for more efficient comparisons between corresponding sub-portions of the respective intermediate assets 206. In some embodiments, in an effort to reduce the overall memory footprint of the fusion operation, one of the image-based intermediate assets (e.g., 206₁) may intentionally have a lower resolution than the other image-based intermediate asset (e.g., 206₂), thus resulting in a potential need to be scaled up, i.e., in order to be applied to or used in network processing block 2043 with the other image-based intermediate assets.

As will be explained in further detail below, in some embodiments, a guidance tile generation process 208 may first be performed between the second intermediate asset and the (optionally upscaled) first intermediate asset before the additional detail transfer of network processing block 2043 occurs. According to some embodiments, the guidance tile generation process 208 may be used to find the best guidance tile for feature transfer from the higher resolution second intermediate asset to the first intermediate asset. In some instances, the appropriate guidance tile from the second intermediate asset for a given tile from the first intermediate asset will simply be the tile from the second intermediate asset that most closely contains the same captured scene content as the tile from the first intermediate asset (e.g., after estimating an optical flow and then registering the two intermediate assets). However, in other instances, such as when then optical flow estimate between the two intermediate assets is rather large, there may not be corresponding tiles in the second intermediate asset that contain the same captured scene content as a given tile in the first intermediate asset. In such instances, the guidance tile may be identified as the tile that is the most similar in feature space, i.e., without regard to the output of any per-tile homography estimation processes, or the like. Such guidance tiles may still have relevant detail information in them, however, which may be beneficial to attempt to transfer to the corresponding portions of the first intermediate asset.

Once any necessary scaling operations have been performed and the guidance tiles have been identified at block 208, the deep network detail transfer operations may be performed on a tile-by-tile basis at network processing block 2043. In some embodiments, each tile may share an overlapping border pixel region of a predetermined number of pixels with each neighboring tile, wherein the pixels in such overlapping border pixel regions may be blended (e.g., according to a predetermined weighting function) before the individual tiles are reassembled to the full size of the second intermediate asset.

At block 210, any desired tuning or post-processing may be applied to the fused high-resolution image, to generate the final fused high-resolution output image 212. Examples of the types of tuning and post-processing operations that may be performed on the fused image include: luma filtering (e.g., to maintain a consistent color appearance between intermediate assets), sharpening operations, determining a percentage of high-resolution or texture details to be added back in to the fused image (e.g., based on an estimated amount of blurring, luma values, skin/face segmentation regions, etc.), subject relighting, rotating, and/or additional hardware upscaling or downscaling, e.g., based on a zoom/resolution-level requested by a user.

### Deep Network-Enhanced Image Detail Transfer

As alluded to above, according to some embodiments, a process of deep network-enhanced image detail transfer is performed using two or more intermediate assets as input that does not introduce unwanted ghosting/blurring into the final output image. One way in which such a deep network-enhanced image detail transfer process is performed involves a multi-scale feature fusion process, wherein details are transferred from higher-resolution image portions of one intermediate asset to corresponding lower-resolution image portions of another intermediate asset in feature space.

As also alluded to above, one way to improve the efficiency of such deep network-enhanced image detail transfer processes is to operate on image tiles (i.e., sub-portions, e.g., 800 pixel by 800 pixel rectangular regions) rather than entire images, which may involve identifying and/or generating the best high-resolution “guidance” tiles from a higher-resolution image (e.g., such as the second intermediate asset, described above) for each tile comprising a lower-resolution image (e.g., such as the first intermediate asset, described above). According to some embodiments, the guidance tile generation process may preferably be based on computing a per-tile homography estimate and avoiding any dense warping operations, which could be computationally expensive and/or introduce unwanted artifacts, such as distortions for occlusion regions, ghosting, etc.

Thus, according to some embodiments, a guidance tile generation process may begin by performing a global registration operation between the first and second intermediate assets. Such a process may be used to determine a single, global homography matrix that best aligns the majority of the pixels of the second intermediate asset with the corresponding pixels of the first intermediate asset.

Next, a dense optical flow (OF) field may be estimated between (optionally downscaled) versions of the first intermediate asset and second intermediate asset. According to some embodiments, a network-based OF field estimate may be used. Then, a per-tile homography estimation may be extracted from the OF estimation, e.g., using RANSAC or other model-fitting techniques. Next, the determined global homography and local tile homographies may be chained together and applied as a final homography transformation for each tile, resulting in just a single alignment transformation needing to be performed for each tile.

In some implementations, each per-tile homography may be checked (e.g., using a Principal Component Analysis (PCA) technique, or the like) to ensure that the local per-tile homography is valid (e.g., not deemed to be a statistical outlier among the determined per-tile homographies). If the local homography estimate fails the PCA check for a given tile (e.g., is deemed to be a statistical outlier based on a calculated distance between the estimated homography and the center of a set of homographies estimated beforehand in the feature space projected by PCA being larger than a determined threshold), then the embodiment may simply fall back to the aforementioned global homography estimate. Once the homography check has been passed and each first intermediate asset tile's corresponding higher-resolution guidance tile from the second intermediate asset has been identified, the information from the first and second intermediate assets (i.e., including the guidance tile information) may be fed into a third neural network (e.g., as will be described in more detail below with reference to FIG. 3), wherein the third neural network is configured to combine the first and second intermediate assets (e.g., transferring additional detail from the second intermediate asset to the first intermediate asset), to generate an output image having a resolution greater than the images from the incoming image stream that were used to form the first intermediate asset (e.g., the output image may have the resolution of the second intermediate asset itself, or of the higher-resolution image capture that was initially used to produce the second intermediate asset).

Referring now to FIG. 3, an example 300 of a neural network architecture that may be used for performing high-resolution and low latency machine learning-enhanced image fusion and/or noise reduction is illustrated, according to one or more embodiments. Exemplary neural network 300 exhibits several characteristics allowing it to efficiently transfer details from a higher-resolution image guidance tile to a corresponding lower-resolution image tile in feature space. For example, network 300 is configured to perform non-local matching of features, e.g., through the use of attention modules (e.g., transformers). Such modules may allow the network to identify and understand how distant data elements influence and depend on one another. Network 300 may also exhibit improved detail perseveration, e.g., through the use of multiple (and, optionally, disentangled) encoders. Finally, the design of network 300 may also result in improved ghosting artifact mitigation, through use of its robust fusion modules.

As will now be described in greater detail, network 300 achieves greater computational efficiency through, inter alia: using a small number of Residual Blocks in the deeper layers of the network, leveraging a multi-head attention module for determining non-local contextual correspondences, performing fusion operations at multiple scales (which improves detail transfer, particularly for static scenes), relaxing the detail transfer burden from the attention modules, and performing kernel pruning and quantization (e.g., 8-bit quantization) where appropriate. Additional details regarding non-local attention modules and neural network architectures that may be used for performing high-resolution feature aggregation and detail transfer from portions of a first image to corresponding low-resolution features from other captured images may be found in the commonly-assigned patent application having U.S. Ser. No. 17/658,706, entitled, “Reference-Based Super-Resolution for Image and Video Enhancement,” filed Apr. 11, 2022 (hereinafter, “the '706 application”), and which is hereby incorporated by reference in its entirety.

As shown in FIG. 3, one or more input intermediate image assets (e.g., 302/304) may be combined by the network 300 to produce a high-resolution output image 368. Beginning with the first intermediate asset, e.g., lower-resolution image 302, it is shown that the image data for the lower-resolution first intermediate asset 302 (e.g., as divided into tile-based sub-portions, as described above) follows a first processing path through the network 300, beginning with one more convolutional layers 308/310, which may, e.g., have 16 channels (or some other multiple of eight number of channels, as desired for a given implementation).

Similarly, the image data for the higher-resolution second intermediate asset 304 (e.g., as divided into tile-based sub-portions, as described above) follows a second processing path through the network 300, beginning with one more convolutional layers 318/320. Next, the data from each intermediate asset is processed by pathway 321 at a first scale. In particular, the first intermediate asset 302 data from convolutional layer 310 may be processed by another one or more convolutional layers 328, while the second intermediate asset 304 data from convolutional layer 320 may be processed by another one or more convolutional layers 322, before each output is combined at Low-Resolution (LR)/High-Resolution (HR) Feature Fusion block 334.

In parallel, the data from each intermediate asset is processed by pathway 331 at a second scale (e.g., a pathway having a smaller resolution but a greater feature depth than pathway 321). In particular, the first intermediate asset 302 data from convolutional layer 328 may be processed by another one or more convolutional layers 330, while the second intermediate asset 304 data from convolutional layer 322 may be processed by another one or more convolutional layers 324, before each output is combined at LR/HR Feature Fusion block 336.

In a third parallel processing path, the data from each intermediate asset is processed by pathway 341 at a third scale (e.g., a pathway having a smaller resolution but a greater feature depth than either pathway 321 or 331). In particular, the first intermediate asset 302 data from convolutional layer 330 may be processed by another one or more convolutional layers 332, while the second intermediate asset 304 data from convolutional layer 324 may be processed by another one or more convolutional layers 326, before each output is combined at LR/HR Attention and Feature Fusion block 338 (e.g., a non-local multi-head attention module). The output of block 338 (which represents the fusion of HR and LR details based on non-local, contextual correspondences) may then be processed through one or more convolutional layers (340), residual blocks (342), additional convolutional layers (344), and then upscaled (346), as necessary, so that the output channels may be concatenated at block 348 with the output from the LR/HR Feature Fusion block 336 of pathway 331.

The output of concatenation block 348 may then likewise be processed through one or more convolutional layers (350), residual blocks (352), additional convolutional layers (354), and then upscaled (356), as necessary, so that the output channels may be concatenated at block 358 with the output from the LR/HR Feature Fusion block 334 of pathway 321.

Then, the output of concatenation block 358 may likewise be processed through one or more convolutional layers (360), residual blocks (362), additional convolutional layers (364), and then upscaled (366), as necessary, so that the output channels may be concatenated at block 312 with the output from the convolutional layer 310 (i.e., the original features from the lower-resolution first intermediate asset 302). The output of block 312 may then itself pass through one or more convolutional layers 314 before it is combined (e.g., in an element-wise addition) at block 316 with a version of the first intermediate asset image data 302 that has been smoothed (e.g., via a Gaussian smoothing operation) at block 306. The output of block 316 is then the aforementioned final high-resolution fused output image 368.

Compared with LR/HR Attention and Feature Fusion block 338, LR/HR Feature Fusion blocks 334 and 336 do not utilize a multi-head Attention module, and instead perform direct fusion of features, which works well for static scenes (i.e., where the homography between the first and second intermediate assets aligns very well). As may now be understood, this design choice allows the network 300 to transfer detail from the HR intermediate asset (304) to the LR intermediate asset (302) more aggressively at certain scales. It also allows for more aggressive quantization through the network 300, which speeds up overall network latency.

### Methods of Performing High-Resolution and Low Latency Machine Learning-Enhanced Image Fusion

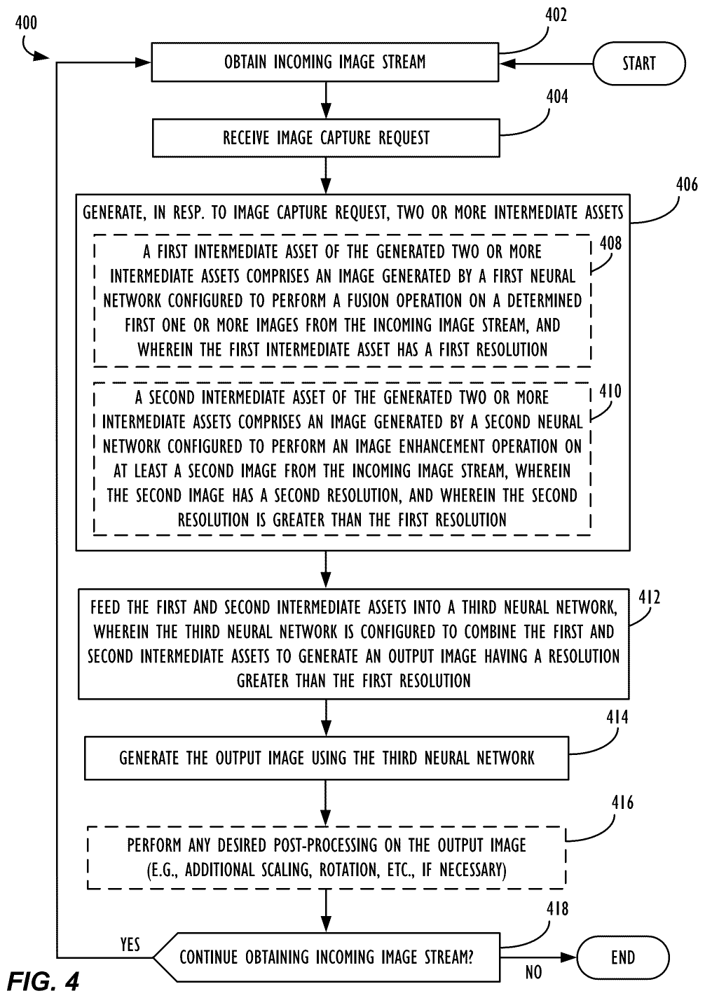

Referring now to FIG. 4, a flow chart illustrating another method 400 of performing high-resolution and low latency machine learning-enhanced image fusion and/or noise reduction using one or more intermediate assets is shown, according to one or more embodiments. The method 400 may begin at Step 402 by obtaining an incoming image stream (e.g., image stream 100 of FIG. 1). Next, at Step 404, the method 400 may receive an image capture request (e.g., image capture request 106 of FIG. 1). In response to the image capture request, at Step 406, the method 400 may generate two or more intermediate assets based on the incoming image stream. In some embodiments, a first intermediate asset may be generated by a first neural network configured to perform a fusion operation on a determined first one or more images from the incoming image stream, wherein the first intermediate asset has a first resolution (Step 408), and a second intermediate asset may be generated by a second neural network configured to perform an image enhancement operation (e.g., a denoising operation and/or a demosaicing operation) on a second image from the incoming image stream, wherein the second image has a second resolution, and wherein the second resolution is greater than the first resolution (Step 410).

At Step 412, the method 400 may feed the first and second intermediate assets into a third neural network, wherein the third neural network is configured to combine the first and second intermediate assets to generate an output image having a resolution greater than the first resolution. Neural networks such as the third neural network referred to in Step 412 are described in greater detail above, e.g., with reference to FIG. 3 and network 300.

At Step 414, the third neural network may be used to transfer additional detail from the second intermediate asset to the corresponding portions (e.g., tiles) of the first intermediate asset, thereby producing the output image, which has a resolution greater than the first resolution (e.g., up to and including the second resolution).

If desired, at Step 416, optional post-processing and/or tuning may be performed on the image to generate the final fused output image. For example, additional scaling, rotation, etc., may be necessary, based on the particular “zoom level”/resolution of image requested by the user, e.g., based on the “native” zoom level/resolution of the output of the third neural network. For example, according to some embodiments, the third neural network may be configured to generate an output image having a resolution configured to simulate a particular prime lens (e.g., to simulate a field of view (FOV) of a 24 mm equivalent fixed focal length camera, a 28 mm equivalent fixed focal length camera, a 35 mm equivalent fixed focal length camera, a 48 mm equivalent fixed focal length camera, etc.) Then, if a user has requested a particular zoom level that falls between one of the zoom levels for which there is a pre-trained neural network (e.g., a zoom level equivalent to a 30 mm fixed focal length camera, say), the method may simply select and utilize as the third neural network the pre-trained network that is configured to simulate a prime lens that is the closest to the requested zoom level (e.g., the neural network configured to generate a 28 mm fixed focal length image-equivalent FOV), and then use high-performance hardware accelerators to do any additional scaling, rotation, etc., necessary to bring the output image up to the particular zoom level requested by the user (e.g., up to a 30 mm fixed focal length image-equivalent, in this example).

In still other embodiments, at some user-requested zoom levels, the second neural network may be configured to perform an image enhancement operation (e.g., a denoising operation) on a cropped region from the second image from the incoming image stream. For example, above a certain requested zoom level, the second neural network may instead operate on a central cropped region of the second image (e.g., a central cropping of approximately 70% of the second image's width and 70% of the second image's height would result in about 50% of the original number of image pixels), i.e., rather than doing a naïve 2× downscaling operation on the second image (which would also reduce the original number of pixels by 50%, but would reduce detail level in the central region of the image in the process, due to the downscaling operation). As mentioned above, once the center-cropped region of the second image has been processed by the appropriate second neural network (e.g., the pre-trained neural network that is configured to simulate a prime lens that is the closest to the requested zoom level, say, a network to generate images at a 35 mm focal length-equivalent FOV) to generate the second intermediate asset, any additional scaling needed to reach the user's precise requested zoom level may be performed by hardware accelerators, thus resulting in the final output image having better detail than if the higher-resolution second image had not been used in the generation process at all—while still obtaining improved latency and freezing the captured scene as close as possible to the moment that the user requested the image capture.

At Step 418, if the image capture device has been directed, e.g., by a user, to continue obtaining an incoming image stream (i.e., “YES” at Step 418), the method 400 may return to Step 402. If, instead, the image capture device has been directed, e.g., by a user, to stop obtaining an incoming image stream (i.e., “NO” at Step 418), the method 400 may terminate.

### Exemplary Electronic Computing Devices

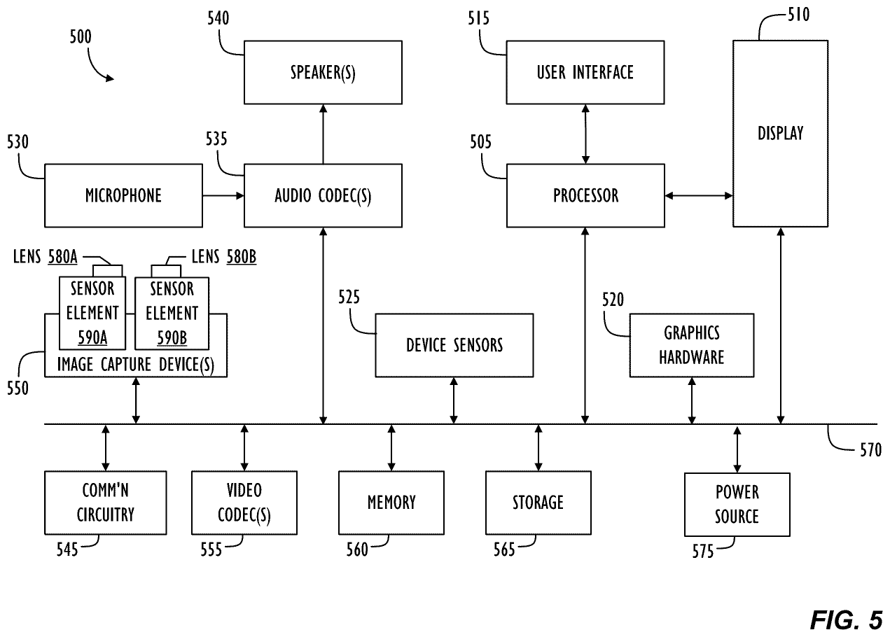

Referring now to FIG. 5, a simplified functional block diagram of illustrative programmable electronic computing device 500 is shown according to one embodiment. Electronic device 500 could be, for example, a mobile telephone, personal media device, portable camera, or a tablet, notebook or desktop computer system. As shown, electronic device 500 may include processor 505, display 510, user interface 515, graphics hardware 520, device sensors 525 (e.g., proximity sensor/ambient light sensor, accelerometer, inertial measurement unit, and/or gyroscope), microphone 530, audio codec(s) 535, speaker(s) 540, communications circuitry 545, image capture device(s) 550, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 555, memory 560, storage 565, and communications bus 570.

Processor 505 may execute instructions necessary to carry out or control the operation of many functions performed by electronic device 500 (e.g., such as the generation and/or processing of images in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 510 may display a video stream as it is captured while processor 505 and/or graphics hardware 520 and/or image capture circuitry contemporaneously generate and store the video stream in memory 560 and/or storage 565. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 550 may comprise one or more camera units configured to capture images, e.g., images which may be processed to help further calibrate said image capture device in field use, e.g., in accordance with this disclosure. Image capture device(s) 550 may include two (or more) lens assemblies 580A and 580B, where each lens assembly may have a separate focal length. For example, lens assembly 580A may have a shorter focal length relative to the focal length of lens assembly 580B. Each lens assembly may have a separate associated sensor element, e.g., sensor elements 590A/590B. Alternatively, two or more lens assemblies may share a common sensor element. In some embodiments, sensor elements 590 may be configured to perform pixel binning operations, e.g., outputting images with a native (e.g., high resolution), or a downscaled (e.g., low resolution) image that is the result of performing said pixel binning operations on the sensor hardware. Image capture device(s) 550 may capture still and/or video images. Output from image capture device(s) 550 may be processed, at least in part, by video codec(s) 555 and/or processor 505 and/or graphics hardware 520, and/or a dedicated image processing unit or image signal processor incorporated within image capture device(s) 550. Images so captured may be stored in memory 560 and/or storage 565.

Memory 560 may include one or more different types of media used by processor 505, graphics hardware 520, and image capture device(s) 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory;
a user interface;
an image capture device; and
one or more processors operatively coupled to the memory, wherein the one or more processors are configured to execute instructions causing the one or more processors to:
obtain an incoming image stream from the image capture device;
receive an image capture request via the user interface;
generate, in response to the image capture request, two or more intermediate assets, wherein:
a first intermediate asset of the generated two or more intermediate assets comprises an image generated by a first neural network configured to perform a fusion operation on a determined first one or more images from the incoming image stream, and wherein the first intermediate asset has a first resolution; and
a second intermediate asset of the generated two or more intermediate assets comprises an image generated by a second neural network configured to perform an image enhancement operation on at least a second image from the incoming image stream, wherein the second image has a second resolution, and wherein the second resolution is greater than the first resolution;
feed the first and second intermediate assets into a third neural network, wherein the third neural network is configured to combine the first and second intermediate assets to generate an output image having a resolution greater than the first resolution; and
generate the output image using the third neural network.

2. The device of claim 1, wherein one or more of the first one or more images are captured before the image capture request is received.

3. The device of claim 2, wherein at least one of: a) the first one or more images; or b) the second image are captured after the image capture request is received.

4. The device of claim 1, wherein the image enhancement operation comprises at least one of a denoising operation or a demosaicing operation.

5. The device of claim 1, wherein the second neural network is further configured to perform the image enhancement operation on a cropped region from the second image from the incoming image stream.

6. The device of claim 1, wherein the second resolution is greater than the first resolution by a factor of n, wherein n is greater than or equal to 2.

7. The device of claim 1, wherein the output image has an improved detail level compared to the first intermediate asset.

8. The device of claim 1, wherein the third neural network is further configured to operate on tiles of the first intermediate asset.

9. The device of claim 8, wherein the one or more processors are further configured to execute instructions causing the one or more processors to:
perform a per-tile homography estimation between tiles of the second intermediate asset and tiles of the first intermediate asset.

10. The device of claim 9, wherein the one or more processors are further configured to execute instructions causing the one or more processors to:
identify a guidance tile in the second intermediate asset for each tile in the first intermediate asset.

11. The device of claim 10, wherein the third neural network is further configured to transfer details to each tile in the first intermediate asset from its corresponding guidance tile in the second intermediate asset.

12. The device of claim 1, wherein the third neural network is further configured to generate the output image having a resolution configured to simulate a particular prime lens.

13. The device of claim 1, wherein the output image has the second resolution.

14. A non-transitory program storage device comprising instructions stored thereon to cause one or more processors to:
obtain an incoming image stream from an image capture device;
receive an image capture request;
generate, in response to the image capture request, two or more intermediate assets, wherein:
a first intermediate asset of the generated two or more intermediate assets comprises an image generated by a first neural network configured to perform a fusion operation on a determined first one or more images from the incoming image stream, and wherein the first intermediate asset has a first resolution; and
a second intermediate asset of the generated two or more intermediate assets comprises an image generated by a second neural network configured to perform an image enhancement operation on at least a second image from the incoming image stream, wherein the second image has a second resolution, and wherein the second resolution is greater than the first resolution;
feed the first and second intermediate assets into a third neural network, wherein the third neural network is configured to combine the first and second intermediate assets to generate an output image having a resolution greater than the first resolution; and
generate the output image using the third neural network.

15. The non-transitory program storage device of claim 14, wherein the third neural network is further configured to operate on tiles of the first intermediate asset.

16. The non-transitory program storage device of claim 15, wherein the instructions stored thereon further cause the one or more processors to:
perform a per-tile homography estimation between tiles of the second intermediate asset and tiles of the first intermediate asset.

17. The non-transitory program storage device of claim 16, wherein the instructions stored thereon further cause the one or more processors to:
identify a guidance tile in the second intermediate asset for each tile in the first intermediate asset.

18. The non-transitory program storage device of claim 17, wherein the third neural network is further configured to transfer details to each tile in the first intermediate asset from its corresponding guidance tile in the second intermediate asset.

19. The non-transitory program storage device of claim 14, wherein the third neural network is further configured to generate the output image having a resolution configured to simulate a particular prime lens.

20. An image processing method, comprising:
obtaining an incoming image stream from an image capture device;
receiving an image capture request;
generating, in response to the image capture request, two or more intermediate assets, wherein:
a first intermediate asset of the generated two or more intermediate assets comprises an image generated by a first neural network configured to perform a fusion operation on a determined first one or more images from the incoming image stream, and wherein the first intermediate asset has a first resolution; and
a second intermediate asset of the generated two or more intermediate assets comprises an image generated by a second neural network configured to perform an image enhancement operation on at least a second image from the incoming image stream, wherein the second image has a second resolution, and wherein the second resolution is greater than the first resolution;
feeding the first and second intermediate assets into a third neural network, wherein the third neural network is configured to combine the first and second intermediate assets to generate an output image having a resolution greater than the first resolution; and
generating the output image using the third neural network.
